(19) United States
(12) Patent Application Publication
(10) Pub. No.: US 2005/0203797 A1
(43) Pub. Date: Sep. 15, 2005

(54) Information distribution method and apparatus, business method and computer-readable storage medium

(75) Inventors: Yasuhiko Isobe, Kawasaki (JP); Teruo Ootake, Kawasaki (JP)

Correspondence Address: STAAS & HALSEY LLP, SUITE 700, 1201 NEW YORK AVENUE, N.W., WASHINGTON, DC, 20005, US

(73) Assignee: FUITSU LIMITED, Kawasaki (JP)

(21) Appl. No.: 10/799,603

(22) Filed: Mar. 15, 2004

(51) Int. Cl. G06F 17/60

(52) U.S. Cl. 705/14

(57) ABSTRACT

A information distribution method distributes contents and advertisements from a provider to a user apparatus via a network. The information distribution method includes distributing an advertisement with a format requested from the user apparatus.

### BACKGROUND OF THE INVENTION

This application is based on a Japanese Patent Application No. 2002-042069 filed Feb. 19, 2002, in the Japanese Patent Office, the disclosure of which is hereby incorporated by reference.

1. Field of the Invention

The present invention generally relates to information distribution methods and computer-readable storage media, and more particularly to an information distribution method for a contents distribution service via a network such as the Internet, and to a computer-readable storage medium which stores a program for causing a computer to distribute information using such an information distribution method. The present invention also relates to an information distribution apparatus and a business method which employ such an information distribution method.

2. Description of the Related Art

The contents distribution service distribute contents, including image information and/or audio information such as movies and music, to users. The contents distribution may be feecharging or free. In the case of the feecharging contents distribution, the contents are distributed to a user who has paid the required fees or has made a contract to pay the required fees. On the other hand, in the case of the free contents distribution, advertising fees are charged to the advertisers who wish to distribute advertisements, and a contents provider distributes the contents by inserting the advertisements, so that user may receive the contents free, together with the inserted advertisements.

When the contents provider one-sidedly inserts the advertisements when distributing the contents, it is difficult to distribute advertisements including matters that would always attract the user's interest. If the contents provider distributes the advertisements including matters that are not interesting to the user, the user will not see and listen to the advertisements with interest, and the advertising effect of the advertisements become extremely poor. As a result, from the point of view of the advertiser, the advertising expenses are not utilized effectively.

Accordingly, it is possible to notify in advance information the user is interested in, such as hobbies of the user, to the contents provider. In this case, the contents provider can distribute, to the user, the advertisements including the matters related to the hobbies and the like of the user. For example, such a method is proposed in a Japanese Laid-Open Patent Application No. 10-79711. According to this proposed method, if a user is interested in sports, the contents provider can select advertisements related to sporting goods, advertisements in which athletes appear, advertisements in which a sport is being played, and the like, and distribute only sports-related advertisements to the user. In addition, the advertising fees to be paid by the advertiser can be determined depending on the number of advertisements or the time (or duration) of the advertisements received by the user. Hence, the user can see and listen to only the advertisements including the matters that are interesting to the user, thereby improving the advertising effect of the advertisements, and enabling the advertiser to effectively utilize the advertising expenses.

The advertisements including the matters selected by the contents provider are distributed to the user by using (i) a first format which inserts the advertisement for a predetermined time before a program, during a program, after a program and/or between consecutive programs, as in the case of a 15-second commercial in the television broadcasting, (ii) a second format which displays the advertisement outside or inside the contents as in the case of banner advertisements, and (iii) a third format which inserts the advertisement indirectly in the contents as in the case of an intra-contents advertisement in which a character appearing in a program rides a bicycle which is to be advertised, for example.

In this specification, the formats of the advertisements which are distributed include formats which are determined by parameters related to time restrictions, parameters related to image restrictions, parameters related to attribute restrictions, and parameters related to audio restrictions. The parameters related to time restrictions include a timing at which the advertisement is to be distributed, and a time (or duration) of one advertisement. The parameters related to image restrictions include a position on a screen where the advertisement is displayed, color and tone of the advertisement, whether or not to use scrolling and/or blinking in the advertisement, whether or not a dynamic image is to be used for the advertisement, and whether or not a still image is to be used for the advertisement. The parameters related to attribute restrictions include whether the matters included in the advertisement are outside or inside the contents, and whether the advertisement is independent of or synchronized to the contents. The parameters related to audio restrictions include a volume and the like.

According to the proposed method described above, the user can see and listen to only the advertisements including the matters interesting to the user. However, the format of the advertisement which is distributed is determined by the contents provider. For this reason, there was a problem in that the user may not always receive the advertisements with the format desired by the user. Consequently, when the advertisement is distributed with the format which does not suit the user's taste, the user may not see and listen to the matters included in the advertisement even though the user has interest in the matters included in the advertisement, simply because the advertisement is received with the format the user does not like. As a result, there was a problem in that the advertising effect becomes poor in such a case.

### SUMMARY OF THE INVENTION

Accordingly, it is a general object of the present invention to provide a novel and useful information distribution method, information distribution apparatus, business method and computer-readable storage medium, in which the problems described above are eliminated.

Another and more specific object of the present invention is to provide an information distribution method, an information distribution apparatus, a business method and a computer-readable storage medium, which enable a user to select a format of an advertisement to be received, so as to further improve an advertising effect of the advertisement.

Still another object of the present invention is to provide an information distribution method for distributing contents and advertisements from a provider to a user apparatus via a network, comprising distributing an advertisement with a format requested from the user apparatus. According to the information distribution method of the present invention, it is possible for the user to select the format of the advertisement to be received, so as to further improve the advertising effect of the advertisement. Hence, the user can receive the advertisements with the desired format which suits the user's taste. On the other hand, the provider can provide a large variety of advertisements with the formats which are liked by the user, and distribute the advertisements using products such as soft drinks and bicycles which appear within the contents, if the advertiser has no restrictions on distributing such materials. Furthermore, the advertiser can efficiently distribute the advertisements which are unlikely to be disliked by the users. Hence, the advertiser can distribute a large variety of advertisements, such as advertisements which are concentrated within a short time span and advertisements which describe the product in detail.

A further object of the present invention is to provide a computer-readable storage medium which stores a program for causing a computer to distribute contents and advertisements to a user apparatus via a network, the program comprising a procedure causing the computer to distribute an advertisement with a format requested from the user apparatus. According to the computer-readable storage medium of the present invention, it is possible for the user to select the format of the advertisement to be received, so as to further improve the advertising effect of the advertisement. Hence, the user can receive the advertisements with the desired format which suits the user's taste. On the other hand, the provider can provide a large variety of advertisements with the formats which are liked by the user, and distribute the advertisements using products such as soft drinks and bicycles which appear within the contents, if the advertiser has no restrictions on distributing such materials. Furthermore, the advertiser can efficiently distribute the advertisements which are unlikely to be disliked by the users. Hence, the advertiser can distribute a large variety of advertisements, such as advertisements which are concentrated within a short time span and advertisements which describe the product in detail.

Another object of the present invention is to provide an information distribution apparatus for distributing contents and advertisements from a provider to a user apparatus via a network, comprising a unit to distribute an advertisement with a format requested from the user apparatus. According to the information distribution apparatus of the present invention, it is possible for the user to select the format of the advertisement to be received, so as to further improve the advertising effect of the advertisement. Hence, the user can receive the advertisements with the desired format which suits the user's taste. On the other hand, the provider can provide a large variety of advertisements with the formats which are liked by the user, and distribute the advertisements using products such as soft drinks and bicycles which appear within the contents, if the advertiser has no restrictions on distributing such materials. Furthermore, the advertiser can efficiently distribute the advertisements which are unlikely to be disliked by the users. Hence, the advertiser can distribute a large variety of advertisements, such as advertisements which are concentrated within a short time span and advertisements which describe the product in detail.

Still another object of the present invention is to provide a business method for providing free contents service to a user by distributing contents and advertisements from a provider computer to a user apparatus via a network, and charging advertising fees for the advertisements to an advertiser, the business method comprising managing points depending on an advertisement and a format requested from the user apparatus; and distributing the advertisement with the format requested from the user apparatus, and controlling distribution of the contents depending on the points. According to the business method of the present invention, it is possible for the user to select the format of the advertisement to be received, so as to further improve the advertising effect of the advertisement. Hence, the user can receive the advertisements with the desired format which suits the user's taste. On the other hand, the provider can provide a large variety of advertisements with the formats which are liked by the user, and distribute the advertisements using products such as soft drinks and bicycles which appear within the contents, if the advertiser has no restrictions on distributing such materials. Furthermore, the advertiser can efficiently distribute the advertisements which are unlikely to be disliked by the users. Hence, the advertiser can distribute a large variety of advertisements, such as advertisements which are concentrated within a short time span and advertisements which describe the product in detail.

Other objects and further features of the present invention will be apparent from the following detailed description when read in conjunction with the accompanying drawings.

### BRIEF DESCRIPTION OF THE DRAWINGS

FIG. 1 is a diagram showing a structure of a system employing a first embodiment of an information distribution method according to the present invention;

FIG. 2 is a flow chart for explaining an operation of the first embodiment;

FIG. 3 is a time chart for explaining a communication procedure between a provider and a user in the first embodiment;

FIG. 4 is a diagram showing a contents selection menu and an advertisement select mode selection screen;

FIG. 5 is a diagram showing an advertisement receiving format selection screen;

FIG. 6 is a diagram showing a details setting screen;

FIG. 7 is a diagram showing a details setting screen for a case where a mode for independently selecting advertisements is selected;

FIG. 8 is a diagram showing a product category selection screen;

FIG. 9 is a diagram for explaining a display screen of a point list;

FIG. 10 is a diagram showing a details setting screen for a case where a mode for semi-automatically selecting advertisements is selected;

FIG. 11 is a diagram showing a product category selection screen;

FIG. 12 is a flow chart for explaining a portion of the process shown in FIG. 2 in more detail;

FIG. 13 is a flow chart for explaining a portion of the process shown in FIG. 2 in more detail;

FIG. 14 is a flow chart for explaining creation and storage of an advertisement list;

FIG. 15 is a flow chart for explaining a portion of the process shown in FIG. 2 in more detail;

FIG. 16 is a diagram showing an advertisement receiving format selection screen;

FIG. 17 is a flow chart for explaining an adjusting process;

FIG. 18 is a flow chart for explaining an adjusting process;

FIG. 19 is a flow chart for explaining an adjusting process;

FIG. 20 is a flow chart for explaining a portion of the process shown in FIG. 2 in more detail;

FIG. 21 is a flow chart for explaining a portion of the process shown in FIG. 2 in more detail;

FIG. 22 is a flow chart for explaining a portion of the process shown in FIG. 2 in more detail;

FIG. 23 is a flow chart for explaining a process dependent on settings made on the details setting screen shown in FIG. 6;

FIG. 24 is a flow chart for explaining a point give-away process; and

FIG. 25 is a diagram showing formats of received advertisements.

### DESCRIPTION OF THE PREFERRED EMBODIMENTS

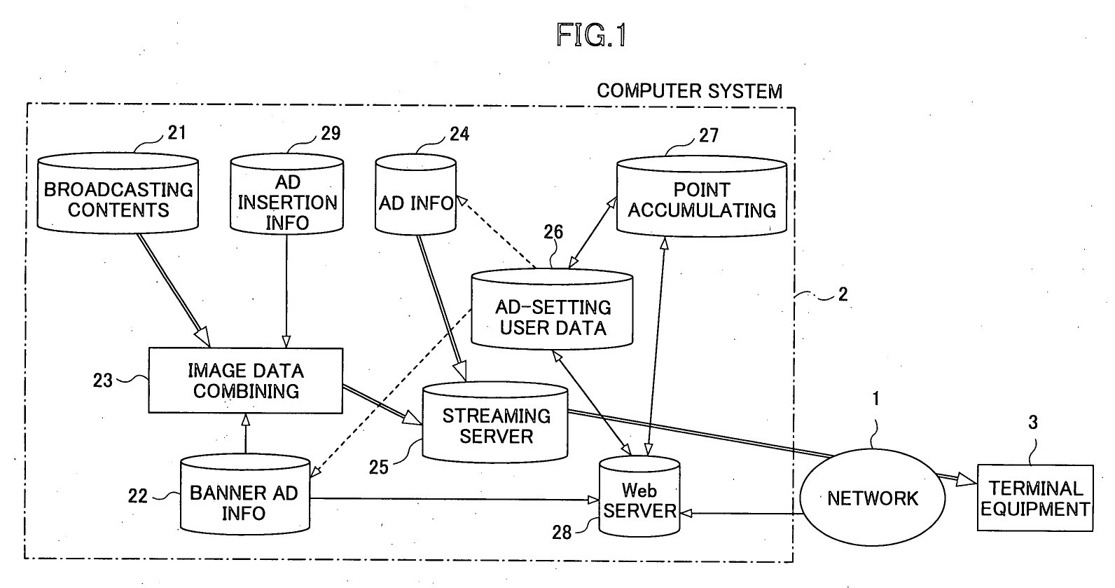

FIG. 1 is a diagram showing a structure of a system employing a first embodiment of an information distribution method according to the present invention. This first embodiment of the information distribution method employs a first embodiment of an information distribution apparatus according to the present invention, a first embodiment of a business method according to the present invention and a first method of a computer-readable storage medium according to the present invention.

The system shown in FIG. 1 includes a computer system 2 and a terminal equipment (apparatus) 3 which are connected via a network 1 such as the Internet. The computer system 2 is provided on the provider end, while the terminal equipment 3 is provided on the user end. The network 1 may be formed by one or more cable networks, one or more wireless networks or, a combination of cable and wireless networks. The computer system 2 is formed by a computer having a known structure including a CPU, a storage unit, and input and output devices such as a display unit. The terminal equipment 3 is formed by a personal computer having a known structure including a CPU, a storage unit and input and output devices such as a display unit. The computer system 2 forms the first embodiment of the information distribution apparatus, and executes a program stored in the first embodiment of the computer-readable storage medium such as the storage unit. The computer-readable storage medium itself may be formed by any kind of recording media capable of storing the program in a computer-readable manner. The first embodiment of the business method is carried out by the computer 1 in the system shown in FIG. 1.

For the sake of convenience, FIG. 1 shows a functional structure of the computer system 2. The computer system 2 includes a broadcasting contents part 21, a banner advertisement information part 22, an image data combining part 23, an advertisement information part 24, a streaming server 25, an advertisement-setting (hereinafter simply referred to as ad-setting) user data part 26 for setting advertisements, a point accumulating part 27, a Web server 28, and an advertisement insertion information part 29. The broadcasting contents part 21 stores broadcasting contents including programs made up of image information and/or audio information such as movies and music. The banner advertisement information part 22 stores information related to banner advertisements. The advertisement insertion information part 29 stores advertisement insertion information such as an advertisement list. The image combining part 23 combines the data from the broadcasting contents part 21 and the banner advertisement information part 22, based on the advertisement insertion information from the advertisement insertion information part 29, if the banner advertisement is to be blended within the contents and displayed, and supplies the combined data to the streaming server 25. On the other hand, when displaying the banner advertisement outside the contents, the Web server 28 attaches the banner advertisement information from the banner advertisement information part 22 depending on the parameters such as the tone from the ad-setting user data part 26, and transmits the banner advertisement information to the terminal equipment 3 via the network 1.

The ad-setting user data part 26 stores ad-setting user data for setting advertisements, including information which determines the format with which the advertisement is to be distributed, such as parameters related to time restrictions, parameters related to image restrictions, parameters related to attribute restrictions, and parameters related to audio restrictions. The parameters related to time restrictions include a timing at which the advertisement is to be distributed, and a time (or duration) of one advertisement. The parameters related to image restrictions include a position on a screen where the advertisement is displayed, color and tone of the advertisement, whether or not to use scrolling and/or blinking in the advertisement, whether or not a dynamic image is to be used for the advertisement, and whether or not a still image is to be used for the advertisement. The parameters related to attribute restrictions include whether the matters included in the advertisement are outside or inside the contents, and whether the advertisement is independent of or synchronized to the contents. The parameters related to audio restrictions include a volume and the like.

The advertisement information from the advertisement information part 24 is supplied to the streaming server 25 depending on the parameters related to the time restrictions, for example, from the ad-setting user data part 26. The streaming server 25 is provided as a server for processing dynamic image, and adds and/or inserts the advertisement from the advertisement information part 24 to the data of the contents or, the combined data of the contents and the banner advertisements, from the image combining part 23, and transmits the data to the terminal equipment 3 via the network 1 if a number of points managed in the point accumulating part 27 has reached a number of points required to acquire the contents requested by the user. As will be described later, the point accumulating part 27 accumulates and manages the points depending on the advertisements and the formats requested by the user.

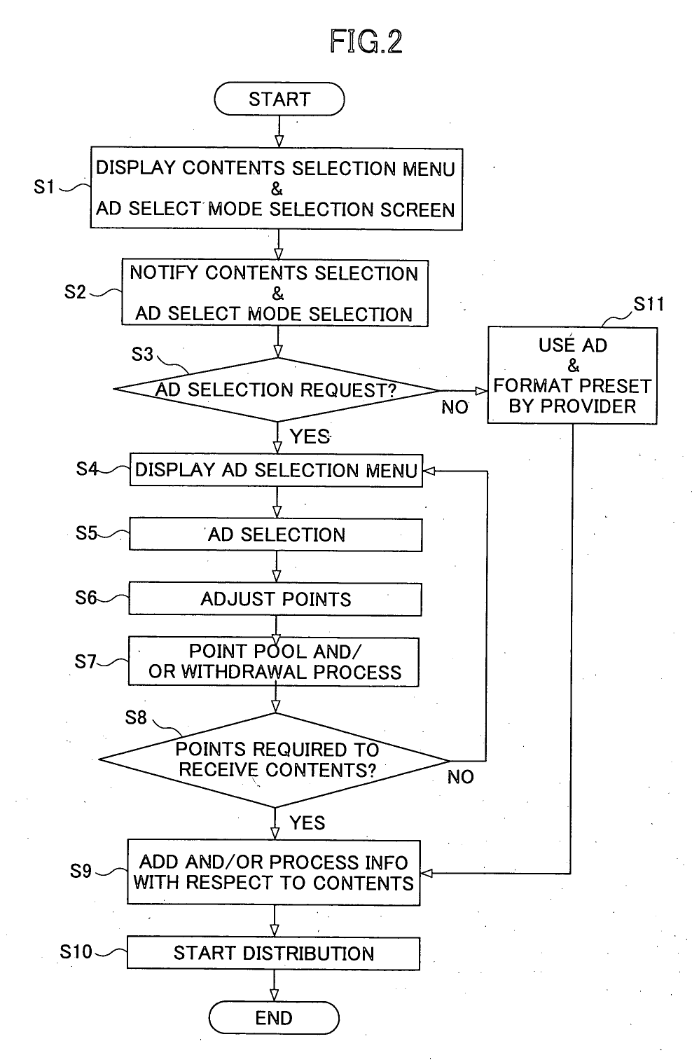

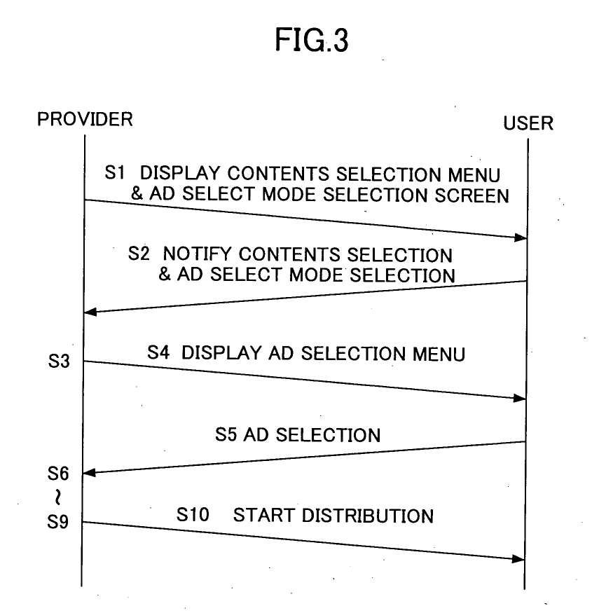

FIG. 2 is a flow chart for explaining an operation of the first embodiment. FIG. 3 is a time chart for explaining a communication procedure between the computer system 2 (provider) and the terminal equipment 3 (user) in the first embodiment. In FIGS. 2 and 3, the same steps are designated by the same reference numerals. Steps S1, S3 and S6 through S10 are carried out by the computer system 2, and steps S2 and S5 are carried out by the terminal equipment 3.

In FIGS. 2 and 3, the step S1 transmits to and displays on the display unit of the terminal equipment 3 a contents selection menu and an advertisement select mode selection screen. The step S2 notifies the contents selection and the advertisement select mode selection made by the user to the computer system 2. The step S3 decides whether or not an advertisement selection request has been made. The process advances to the step S4 if the decision result in the step S3 is YES. The step S4 transmits to and displays on the display unit of the terminal equipment 3 the advertisement selection menu. The step S5 notifies the advertisement selection made by the user to the computer system 2.

The step S6 adjusts the number of points that are accumulated depending on the advertisement and the format selected (requested) by the user, in a case where an automatic point adjustment is set. The step S7 carries out a point pool and/or withdrawal process. The step S8 decides whether or not a number of points required to receive the contents selected by the user is accumulated, and the process returns to the step S4 if the decision result in the step S8 is NO.

On the other hand, if the decision result in the step S8 is YES, the step S9 adds and/or processes information according to the advertisement and the format selected by the user, with respect to the contents selected by the user. The step S10 starts to transmit the advertisement having the selected format and the selected contents to the terminal equipment 3, and the process ends.

If the decision result in the step S3 is NO, the step S11 selects the advertisement and the format of the advertisement which are preset in the computer system 2, and the process advances to the step S9. Hence, in this case, the step S9 adds and/or processes the information according to the advertisement and the format selected by the provider. The step S10 starts to transmit the advertisement having the selected format and the selected contents to the terminal equipment 3, and the process ends.

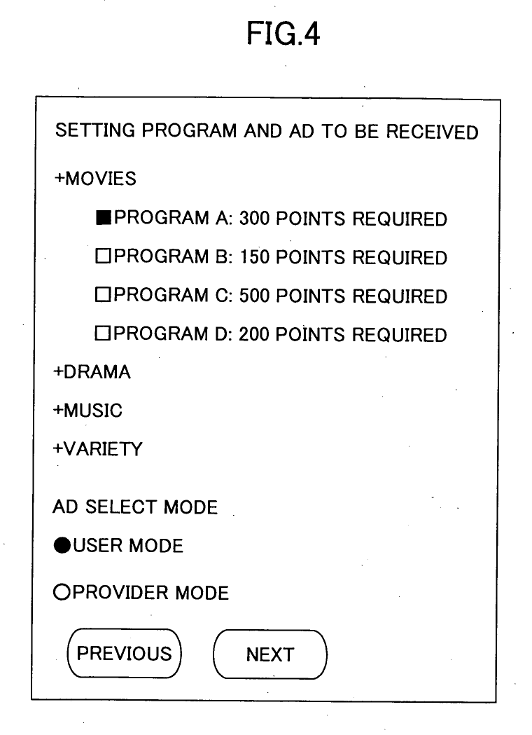

FIG. 4 is a diagram showing the contents selection menu and the advertisement select mode selection screen which are displayed on the display unit of the terminal equipment 3 in the step S1. In FIG. 4 and each of the screens which will be described hereunder, a selected item is indicated by a symbol “ [symbol] ” or a symbol “∘”, and a non-selected item is indicated by a symbol “□” or a symbol “◯”.

FIG. 4 shows a case where a program A requiring 300 points to receive, a program B requiring 150 points to receive, a program C requiring 500 points to receive, a program D requiring 200 points to receive, a drama, a music program and a variety program are selectable as the contents. In addition, the advertisement select mode is selectable between a user mode in which the setting of the advertisements to be received, that is, the format of the advertisements to be received, is set by the user, and a provider mode in which the setting of the advertisements to be received, that is, the format of the advertisements to be received, is set by the provider. In the particular case shown in FIG. 4, it is assumed for the sake of convenience that the step S2 selected the program A as the contents and the user mode in which the advertisements to be received is set by the user, and the decision result in the step S3 is YES. However, in a case where the provider mode in which the advertisements to be received is set by the provider, the decision result in the step S3 becomes NO. The selection on the screen may be made by a known method using a keyboard and/or a mouse which are included in the input and output device of the terminal equipment 3.

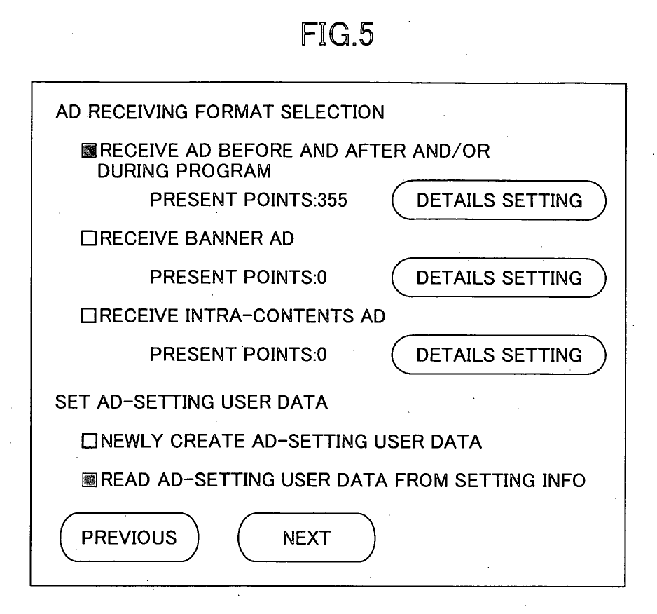

FIG. 5 is a diagram showing an advertisement receiving format selection screen which is displayed on the display unit of the terminal equipment 3 when the user mode in which the advertisements to be received is set by the user is selected on the screen shown in FIG. 4. In other words, FIG. 5 shows the selection screen which is displayed in the step S4. FIG. 5 shows a case where a format which receives the advertisements before and after and/or during the program, a format which receives the banner advertisements, and a format which receives the intra-contents advertisements, are selectable as the advertisement receiving format. In addition, FIG. 5 shows a case where a mode which newly creates the ad-setting user data and a mode which reads setting information from the ad-setting user data, are selectable as the mode for setting the ad-setting user data for setting the advertisements. The present number of points owned by the user and a “details setting” button are displayed with respect to each selectable receiving format.

The ad-setting user data corresponds to the setting information stored in the computer system 2 or in the terminal equipment 3. FIG. 1 shows a case where the ad-setting user data part 26 for setting the advertisements is provided in the computer system 2. The setting information includes data indicating the user's taste (or preference), such as the received advertisement information (for example, code number) which is set and stored by the user in the past at a certain point in time, the detailed data (for example, setting of the banner advertisements), and a log indicating the advertisement to which the user generated a reception reject signal or the like. In FIG. 5, the mode which reads the setting information from the ad-setting user data is selected, and the read setting information is used as a default value when making a next menu selection. Accordingly, various selection screens are displayed using the data read from the ad-setting user data as default values, so as to urge the user to make inputs related to changes, new settings and the like. When an “end” button is selected, the selection made on the selection screen is asserted and the selection process is ended.

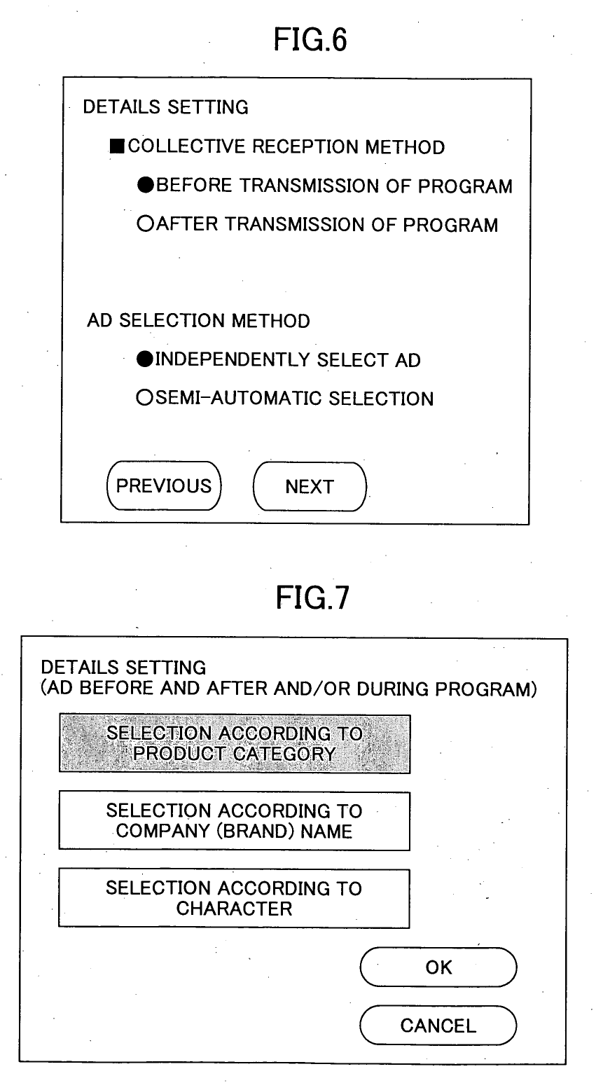

FIG. 6 is a diagram showing a details setting screen which is displayed on the display unit of the terminal equipment 3 when the format which receives the advertisements before and after and/or during the program is selected on the selection screen shown in FIG. 5 and the “details setting” button is selected on the selection screen. FIG. 6 shows a case where an advertisement collective reception method and an advertisement selection method are selectable. When the advertisement collective reception method is not selected, the reception of the advertisements during the broadcasting of the program is selected. However, it is of course possible to provide, on the details setting screen shown in FIG. 6, an item for selecting the reception of the advertisements during the broadcasting of the program. With respect to the advertisement collective reception method, it is possible to select a reception before the broadcasting of the program and a reception after broadcasting of the program. The number of points gained by selecting the reception after the broadcasting of the program may be set smaller than the number of points gained by selecting the reception before the broadcasting of the program. On the other hand, with respect to the advertisement selection method, it is possible to select a mode for independently selecting the advertisements and a mode for semi-automatically selecting the advertisements. FIG. 6 shows a case where the reception before the broadcasting of the program is selected as the advertisement collective reception method, and the mode for independently selecting the advertisements is selected as the advertisement selection method. In FIGS. 4 through 6, the display screen returns to a previous screen when a “previous” button is selected, and the display screen advances to a next screen when a “next” button is selected.

The details setting screen shown in FIG. 6 may be displayed in an overlapping manner on the selection screen shown in FIG. 5.

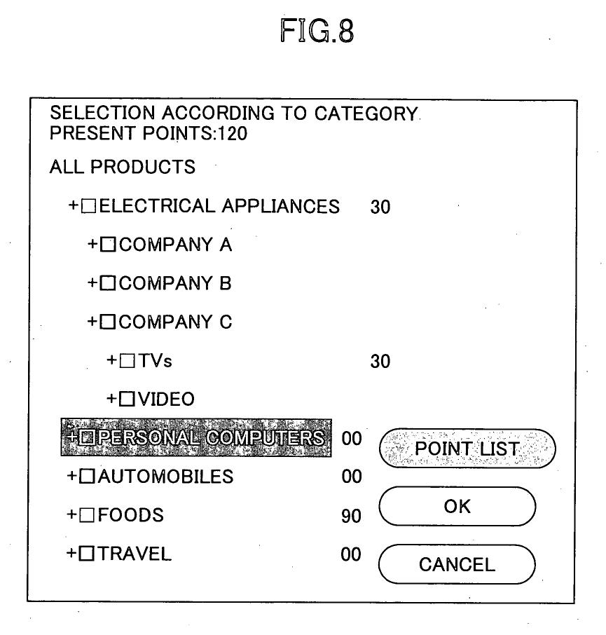

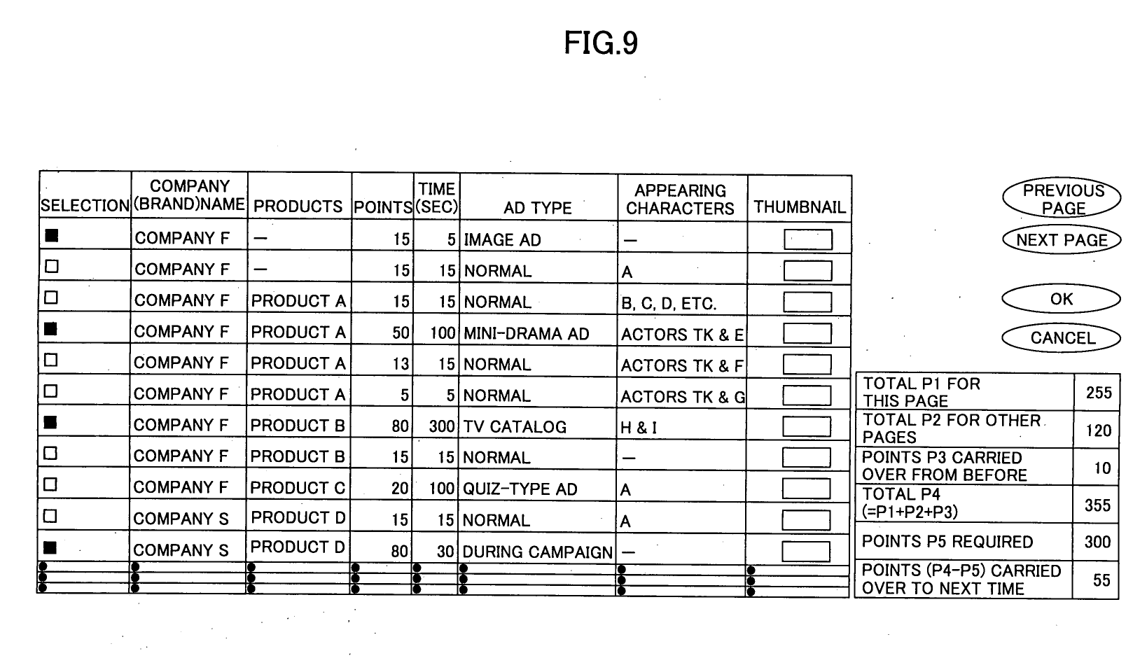

FIG. 7 is a diagram showing a details setting screen for a case where the mode for independently selecting advertisements is selected as the advertisement selection method on the details setting screen shown in FIG. 6. In the details setting screen shown in FIG. 7, it is possible to select how to search and select the advertisements from the advertisements which are providable by the computer system 2. More particularly, the advertisements can be selected according to the product category, selected according to the company (brand) name, and selected according to the characters (celebrities and the like). When a “selection according to the product category” button is selected, the user selects a product of interest, to thereby make it possible to select the advertisements related to the selected product. When a “selection according to the company (brand) name” button is selected, the user selects a company of interest, to thereby make it possible to select the advertisements related to the selected company and the products of the selected company. In addition, when a “selection according to the characters” button is selected, it is possible to select the advertisements in which one or more characters, such as movie stars the user is interested in, appear. When an “OK” button is selected, the selection made on the details setting screen shown in FIG. 7 and selections made on screen shown in FIGS. 8 and 9 are affirmed. On the other hand, when a “cancel” button is selected, the selection made on the details setting screen shown in FIG. 7 is cancelled.

FIG. 8 is a diagram showing a product category selection screen which is displayed on the display unit of the terminal equipment 3 when the selection according to the product category is selected on the details setting screen shown in FIG. 7. A tree including the present number of points that may be gained by the user, the categories of all of the products, and the products within each category, is displayed on the product category selection screen shown in FIG. 8. For example, the product categories include electrical appliances, personal computers, automobiles, foods, travel and the like. Companies A through C are selectable for the electrical appliances, and a television set (TVs), a video deck (Video) and the like are selectable for the company C. In addition, the number of points that will be gained is displayed with respect to each selected product. In this particular case, the present number of points that may be gained by the user is 120 points, because 30 points will be gained by selecting the electrical appliances, 30 points will be gained by selecting the TV, and 90 points will be gained by selecting the foods.

When an “OK” button is selected in FIG. 8, the selections made on the product category selection screen are affirmed. On the other hand, the selections made on the product category selection screen are cancelled when a “cancel” button is selected. When a “point list” button is selected in a state where any one of the items displayed on the product category selection screen shown in FIG. 8 is selected, a point list shown in FIG. 9 is displayed on the display unit of the terminal equipment 3.

FIG. 9 is a diagram for explaining the display screen of the point list. The display screen of the point list shown in FIG. 9 includes a table having columns for the selection, the company (brand) name, the product, the points, the time, the advertisement type, the appearing characters, and the thumbnail. The display screen of the point list also includes a column for the gained points. The thumbnail displays a still or dynamic image of an impressive scene within the advertisement, for example. A plurality of thumbnails may be provided with respect to one selection item. The column for the gained points displays a total P1 of gained points for the page being displayed, a total P2 of gained points for other pages, a number P3 of points carried over from before, a total P4 of gainable points (P4=P1+P2+P3), a number P5 of points required to receive the contents selected by the user, and a number (P4−P5) of points carried over to next time. A previous page before the list is displayed when a “previous page” button is selected, and a next page after the list is displayed when a “next page” button is selected in on the display screen shown in FIG. 9. The selections made on the display screen shown in FIG. 9 are affirmed when an “OK” button is selected, and the selections made on the display screen are cancelled when a “cancel” button is selected. In the particular case shown in FIG. 9, the total P4 exceeds the number P5 of points required to receive the contents selected by the user, and thus, the series of advertisement selecting operation is completed when the “OK” button is selected, thereby making it possible to receive the selected contents. Of course, the selection items in the list shown in FIG. 9 may be rearranged using a known sorting function.

Therefore, when the advertisements on the display screen shown in FIG. 9 are selected and the total P4 of gainable points reaches the number of points required to receive the contents selected by the user, the advertisement selecting operation is ended, and the surplus points are accumulated in the point accumulating part 27 shown in FIG. 1 which manages the number of points owned by each user independently. Each user may be identified by the computer system 2 using a known personal identification method, such as a known log-in method which uses a user ID.

The product category selection screen shown in FIG. 8 may be displayed in an overlapping manner on the details setting screen shown in FIG. 7. In addition, the display screen of the point list shown in FIG. 9 may be displayed in an overlapping manner on the product category selection screen shown in FIG. 8.

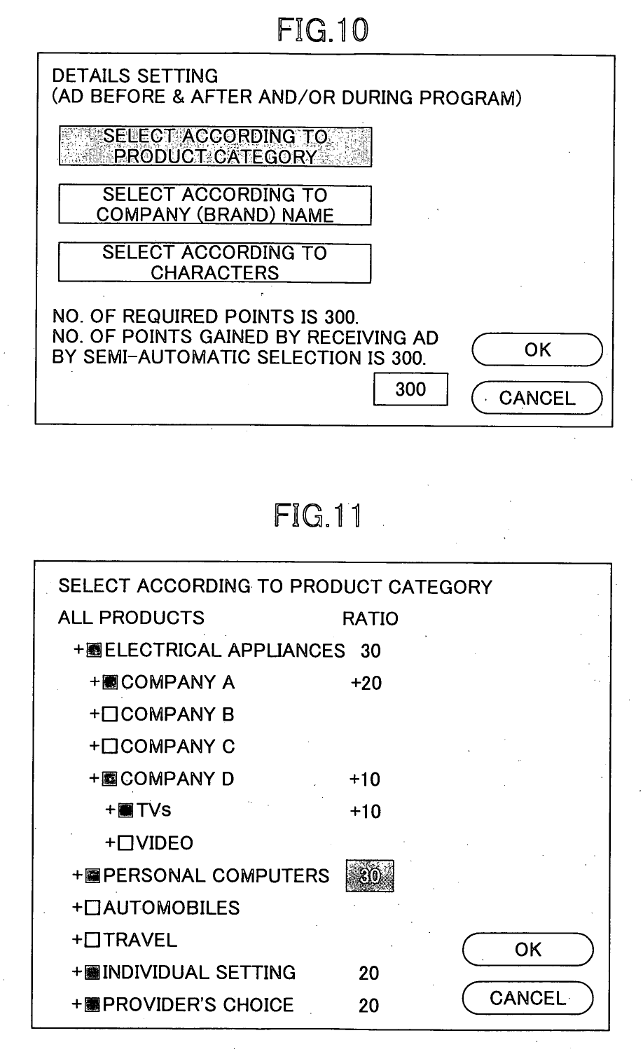

FIG. 10 is a diagram showing a details setting screen which is displayed on the display unit of the terminal equipment 3 for a case where the mode for semi-automatically selecting the advertisements is selected on the details setting screen shown in FIG. 6. In the details setting screen shown in FIG. 10, it is possible to select how to search and select the advertisements from the advertisements which are providable by the computer system 2, similarly to the details setting screen shown in FIG. 7. More particularly, the advertisements can be selected according to the product category, selected according to the company (brand) name, and selected according to the characters (celebrities and the like). When the selection according to the product category is selected, the user selects a product of interest, to thereby make it possible to select the advertisements related to the selected product. When the selection according to the company (brand) name is selected, the user selects a company of interest, to thereby make it possible to select the advertisements related to the selected company and the products of the selected company. In addition, when the selection according to the characters is selected, it is possible to select the advertisements in which one or more characters, such as movie stars the user is interested in, appear. When an “OK” button is selected, the selection made on the details setting screen shown in FIG. 10 are affirmed. On the other hand, when a “cancel” button is selected, the selection made on the details setting screen shown in FIG. 10 is cancelled. The details setting screen shown in FIG. 10 further displays, in the form of a message, the number of points required to receive the contents selected by the user and the number of points that will be gained by receiving the advertisements as a result of selecting the mode for semi-automatically selecting the advertisements. In the particular case shown in FIG. 10, the number of points required to receive the contents selected by the user is “300”, and the number of points that will be gained by receiving the advertisements as a result of selecting the mode for semi-automatically selecting the advertisements is “300”.

FIG. 11 is a diagram showing a product category selection screen which is displayed on the display unit of the terminal equipment 3 for a case where the selection according to the product category is selected on the details setting screen shown in FIG. 10. A tree including the categories of all of the products, and the products within each category, is displayed on the product category selection screen shown in FIG. 11. For example, the selectable product categories include electrical appliances, personal computers, automobiles, foods, travel, individual setting, provider's choice (recommendation), and the like. Companies A through C are selectable for the electrical appliances, and a television set (TVs), a video deck (Video) and the like are selectable for the company C. According to the individual setting, products are selected by the computer system 2 at random according to a ratio which will be described later, from the products for which the details are set in the above described mode for independently selecting the advertisements. According to the provider's choice, the product categories and/or products are selected by the computer system 2 at random according to the ratio which will be described later, excluding the products which are set to be rejected by the user. In addition, with respect to the selected product categories and/or products, the user can set a ratio of the number of points to be gained thereby. In this particular case shown in FIG. 11, a ratio “30” is set for the selection of the electrical appliances, a ratio “30” is set for the selection of the personal computers, a ratio “20” is set for the selection of the individual setting, and a ratio “20” is set for the selection of the provider's choice, and the computer system 2 selects the advertisements depending on the ratios of the selected product categories and/or products. Of the ratio “30” set for the selection of the electrical appliances, a ratio “20” is given to the selection of the company A's electrical appliance and a ratio “10” is given to the selection of the company D's electrical appliance (TV). A total of the ratios of the number of points is “100” in the case shown in FIG. 11, but the total of the ratios is of course not limited to “100”.

When an “OK” button is selected on the product category selection screen shown in FIG. 11, the selections made on the product category selection screen are affirmed. On the other hand, the selections made on the product category selection screen shown in FIG. 11 are cancelled if a “cancel” button is selected on the product category selection screen.

The product category selection screen shown in FIG. 11 may be displayed in an overlapping manner on the details setting screen shown in FIG. 10.

Therefore, by setting the ratios of the product categories and/or products, the user can notify the user's general taste (or preference) to the computer system 2. Moreover, it is possible to simultaneously enable both the individual setting such as the selection of the advertisements and the formats on the user end (terminal equipment 3) and the general setting such as the selection of the advertisements and the formats on the provider end, that is, the computer system 2. Furthermore, by selecting the provider's choice, it is possible to provide the user with information of a genre which is not specified by the user.

The advertisement receiving format selection screen and the details setting screen therefor are not limited to those shown in FIGS. 5 and 6. For example, the advertisement receiving format selection screen and the details setting screen therefor may take any form, as long as the advertisements, such as banner advertisements displayed on the side or within the displayed screen, may be freely set to suit the user's taste. In other words, the user who dislikes dynamic image banner advertisements may turn off the dynamic image banner advertisements or, display the dynamic image banner advertisements in inconspicuous colors or tones by adjusting blending, for example. Accordingly, the advertisement receiving format selection menu may include the following check boxes “□” to be checked when being selected, and the details setting screen therefor may include the following items indicated by arrows “→”.
□ Accept advertisements before and after programs and/or during programs
→ Details Setting: Select/reject sponsor company, Select/reject individual advertisements
□ Accept banner advertisements
→ Select/reject sponsor company, Accept dynamic image/Accept advertisements within display screen/Degree of blending (α-value of α-blending in the case of advertisements within display screen)
□ Accept intra-contents advertisements
→ Select/reject sponsor company, Set emphasis (for example, in the case of an advertisement for a soft drink of a company during the program, whether or not to emphasize the vivid color of the soft drink, whether or not to emphasize a scene where a character drinks the soft drink, etc.)

When the mode for receiving the banner advertisements is selected on the advertisement receiving format selection screen shown in FIG. 5, the advertisements may be set similarly as described above in conjunction with FIGS. 7 through 11 on the details setting screen. In addition, it is possible to adjust the number of points by a setting shown in the following Table 1, for example.

TABLE 1

| 1 Banner Ad/Time | | Number of Points |
|---|---|---|
| Display of Small Still Image | | 15 |
| Outside Display Screen | | (Base) |
| Display of Dynamic Image | | +15 |
| Display Within Display Screen | | +15 |
| Size | (Large) | +10 |
| | (Medium) | +5 |
| | (Small) | +0 |
| Tone | (Dark: 51% < α) | +10 |
| | (Medium: | +5 |
| | 11% < α < 50%) | |
| | (Light: α < 10%) | +0 |

In the case of the advertisements displayed on the side or within the display screen, it is assumed that the base is 15 points that are gained for displaying a banner advertisement for 1 hour, where the banner advertisement is a still image which is displayed outside the display screen with a small size and a light color. If the user changes the setting to “dynamic image within the display screen having a medium size and light color” (that is, a dynamic image banner advertisement within the display screen of the contents, which is lightly blended to the contents) as not particularly disliking such, +35 points are additionally gained and 50 points are gained in total. Hence, the user can select the advertisement receiving format in a range within the user's taste (or preference), and receive the program while effectively gaining points. On the other hand, the advertiser can provide advertisements which are conspicuous only to an extent such that the advertisements will not be disliked or passed by the users, thereby enabling the advertiser to maintain favorable impressions to the users.

Therefore, the user can efficiently receive, that is, watch and hear, the advertisements within a short advertising time, by selecting the advertisements having a large number of points that will be gained when selected. In addition, since the advertisements having the large number of points do not necessarily have long advertising times, various forms of providing the advertisements may be generated.

From the point of view of the provider, it is possible to notify the user of the number of points which will be gained when the advertisement is selected by displaying the number of points within the display screen of the advertisement itself or on the selection screen, for example. Moreover, the provider can distribute the program to the user after distributing the advertisements amounting to a certain number of points to the user, and thereafter charge an advertising fee which is dependent on the number of points to the advertiser. As a result, it is possible to realize advertisements having a high advertising effect at a low cost.

Because the contents receivable by the user is determined by the number of points owned by the user, the user can select the advertisements and the combination of the advertisements which suit the user's taste by referring to the number of points, and also select the receiving format of the advertisements which suits the user's taste. In addition, it is possible to set the receiving time of the advertisements to a short time or to a long time in the case of the user's favorite advertisement, for example, so as to cope with various needs of the user. Therefore, the advertisements and the receiving format can be freely selected to suit each user.

If the same advertisement is received repeatedly, the advertising effect of the advertisement may deteriorate, and in this case, it is possible to decrease the number of points that will be gained by receiving the advertisement by 10% every time the same advertisement is received, for example. Moreover, in the case of a story-based advertisement having 10 consecutive episodes, for example, bonus points may be added if all episodes from the first episode to the last (tenth) episode are received by the user, so as to urge the user to positively receive the advertisements.

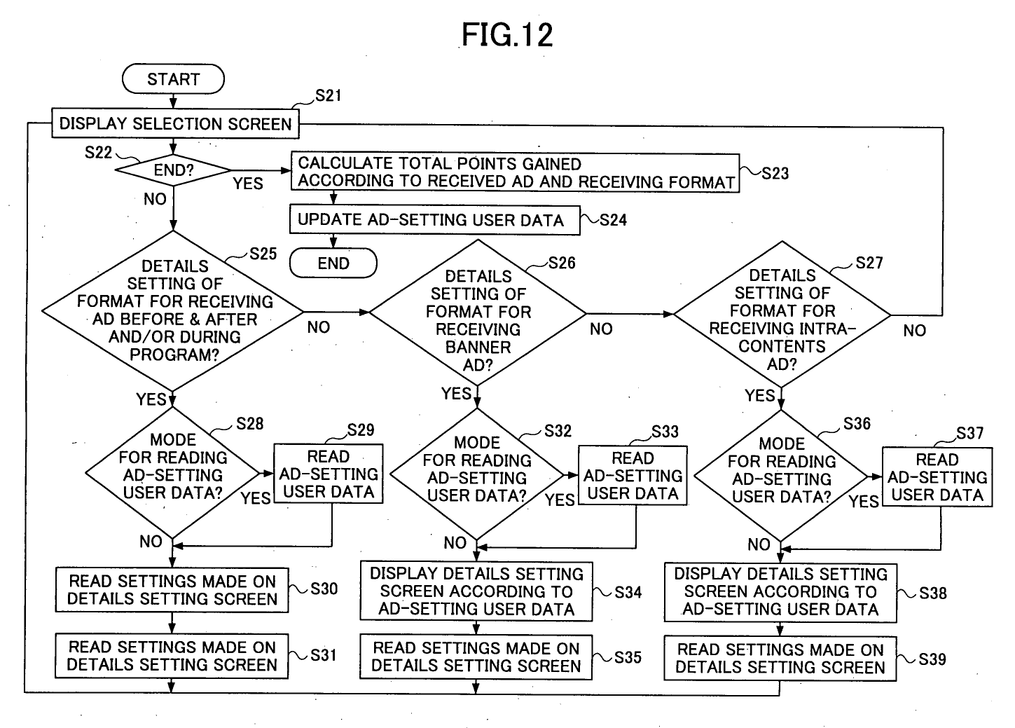

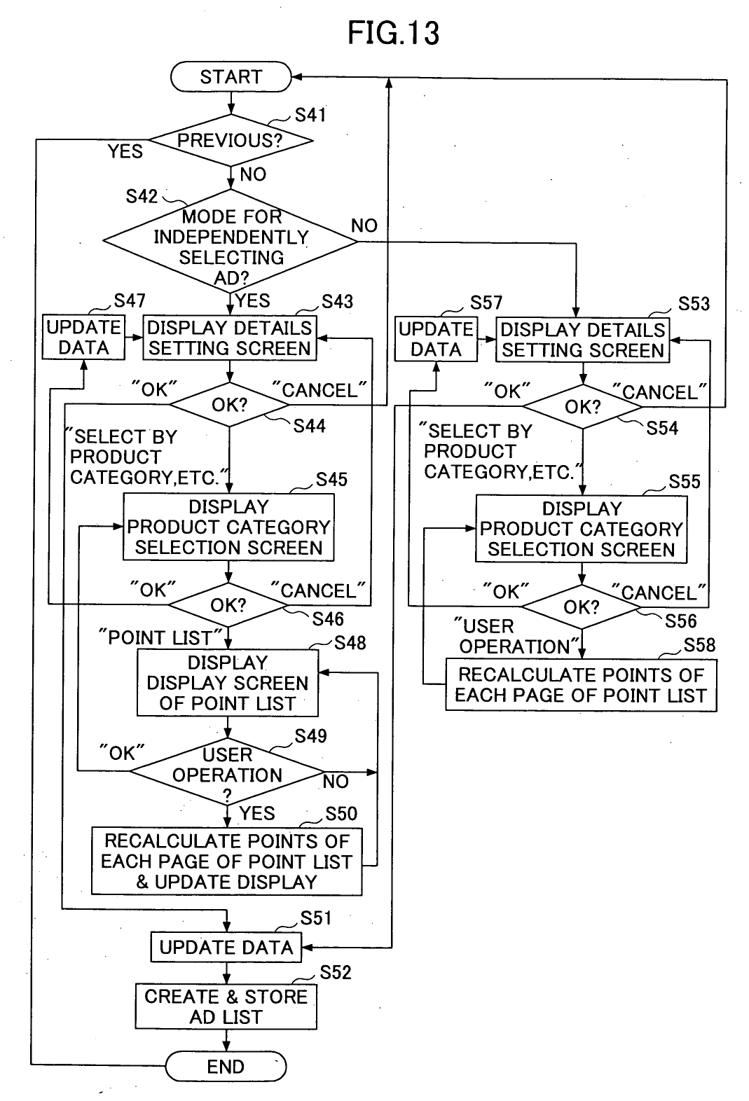

Next, a more detailed description will be given of the processes of the steps S4 and S5 shown in FIG. 2, by referring to FIGS. 12 and 13.

FIG. 12 is a flow chart for explaining a portion of the process shown in FIG. 2 in more detail. More particularly, FIG. 12 shows the operation up to the display of the details setting screen for a case where the format for receiving the advertisements before and after the program and/or during the program is selected on the selection screen shown in FIG. 5, and the “details setting” button is selected on this selection screen.

In FIG. 12, a step S21 displays the selection screen shown in FIG. 5, and a step S22 decides whether or not the “end” button is selected. If the decision result in the step S22 is YES, a step S23 calculates a total number of points gained by the user according to each advertisement and receiving format thereof, and accumulates the total number in the point accumulating part 27. A step S24 updates the ad-setting user data within the ad-setting user data part 26 depending on the total number of points accumulated in the point accumulating part 27, and the process ends.

On the other hand, if the decision result in the step S22 is NO, a step S25 decides whether or not the format for receiving the advertisements before and after the program and/or during the program is selected on the selection screen shown in FIG. 5 and the “details setting” button on this selection screen is selected. If the decision result in the step S25 is NO, a step S26 decides whether or not the format for receiving the banner advertisements is selected and the “details setting” button is selected. If the decision result in the step S26 is NO, a step S27 decides whether or not the format for receiving the intra-contents advertisements is selected and the “details setting” button is selected. The process returns to the step S21 if the decision result in the step S27 is NO.

If the decision result in the step S25 is YES, a step S28 decides whether or not the mode which reads the setting information from the ad-setting user data is selected on the selection screen shown in FIG. 5, as the mode for setting the ad-setting user data for setting the advertisements. If the decision result in the step S28 is YES, a step S29 reads the ad-setting user data from the ad-setting user data part 26 and uses the read ad-setting user data as default values for the settings. After the step S29 or, if the mode which newly creates the ad-setting user data is selected and the decision result in the step S28 is NO, a step S30 displays the details setting screen shown in FIG. 6 for setting the details with respect to the format for receiving the advertisements before and after the program and/or during the program, according to the ad-setting user data. In addition, a step S31 reads the settings made on the details setting screen shown in FIG. 6, and the process returns to the step S21. The details of the step S31 will be described later in conjunction with FIG. 13.

If the decision result in the step S26 is YES, a step S32 decides whether or not the mode which reads the setting information from the ad-setting user data is selected on the selection screen shown in FIG. 5, as the mode for setting the ad-setting user data for setting the advertisements. If the decision result in the step S32 is YES, a step S33 reads the ad-setting user data from the ad-setting user data part 26 and uses the read ad-setting user data as default values for the settings. After the step S3 or, if the mode which newly creates the ad-setting user data is selected and the decision result in the step S32 is NO, a step S34 displays the details setting screen shown in FIG. 6 for setting the details with respect to the format for receiving the banner advertisements, according to the ad-setting user data. In addition, a step S35 reads the settings made on the details setting screen shown in FIG. 6, and the process returns to the step S21.

If the decision result in the step S27 is YES, a step S36 decides whether or not the mode which reads the setting information from the ad-setting user data is selected on the selection screen shown in FIG. 5, as the mode for setting the ad-setting user data for setting the advertisements. If the decision result in the step S36 is YES, a step S37 reads the ad-setting user data from the ad-setting user data part 26 and uses the read ad-setting user data as default values for the settings. After the step S37 or, if the mode which newly creates the ad-setting user data is selected and the decision result in the step S36 is NO, a step S38 displays the details setting screen shown in FIG. 6 for setting the details with respect to the format for receiving the intra-contents advertisements, according to the ad-setting user data. In addition, a step S39 reads the settings made on the details setting screen shown in FIG. 6, and the process returns to the step S21.

FIG. 13 is a flow chart for explaining a portion of the process shown in FIG. 2 in more detail. More particularly, FIG. 13 shows the operation up to the display of the details setting screen for a case where the advertisement selection method is selected and the details setting screens shown in FIGS. 7 and 8 are displayed.

The process shown in FIG. 13 is started when carrying out the process of the step S31 shown in FIG. 12, and a step S41 shown in FIG. 13 decides whether or not the “previous” button is selected on the details setting screen shown in FIG. 6. If the decision result in the step S41 is YES, the process returns from the step S31 to the step S21 in FIG. 12. On the other hand, if the decision result in the step S41 is NO, a step S42 decides whether or not the mode for independently selecting the advertisements is selected as the advertisement selection method. The process advances to a step S43 if the decision result in the step S42 is YES, and the process advances to a step S53 which will be described later if the decision result in the step S42 is NO.

The step S43 displays the details setting screen shown in FIG. 7, and a step S44 decides whether the “OK” button or the “cancel” button on the details setting screen shown in FIG. 7 is selected and whether the “selection according to the product category” button, the “selection according to the company (brand) name” button or the “selection according to the characters” button is selected. If the “cancel” button is selected, the process returns to the step S41 from the step S44. On the other hand, if the “OK” button is selected, the process advances to a step S51 which will be described later from the step S44. In addition, if the “selection according to the product category” button, the “selection according to the company (brand) name” button or the “selection according to the characters” button is selected, the process advances to a corresponding step from the step S44. For the sake of convenience, a description will be given of a case where the “selection according to product category” button is selected, as described above in conjunction with FIG. 7.

In this case, the process advances to a step S45 which displays the product category selection screen shown in FIG. 8. A step S46 decides whether the “OK” button, the “cancel” button or the “point list” button is selected on the product category selection screen shown in FIG. 8. If the “OK” button is selected, the process advances to a step 47 from the step S46. The step S47 updates the data within the ad-setting user data part 26, and the process returns to the step S43. If the “cancel” button is selected, the process returns to the step S43 from the step S46. In addition, if the “point list” button is selected, the process advances to a step S48 from the step S46.

The step S48 displays the display screen of the point list shown in FIG. 9. A step S49 decides whether or not a user operation is made on the display screen of the point list shown in FIG. 9. More particularly, if the decision result in the step S49 is YES and the “OK” button is selected, the process returns to the step S45. If the decision result in the step S49 is NO, the process returns to the step S48. If the decision result in the step S49 is YES, a step S50 recalculates the points of each page of the point list shown in FIG. 9 and updates the display, and the process returns to the step S48.

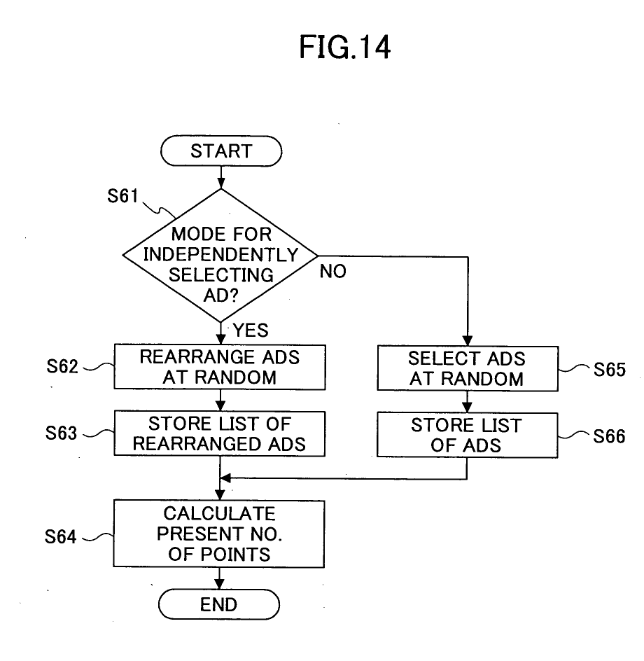

The step S51 updates the data within the ad-setting user data part 26. A step S52 creates and stores an advertisement list which will be described later in conjunction with FIG. 14, and the process returns to the step S31 shown in FIG. 12.

A step S53 displays the details setting screen shown in FIG. 10, and a step S54 decides whether the “OK” button or the “cancel” button is selected on the details setting screen shown in FIG. 10 and whether the “selection according to the product category” button, the “selection according to the company (brand) name” button or the “selection according to the characters” button is selected. If the “cancel” button is selected, the process returns to the step S41 from the step S54. If the “OK” button is selected, the process advances to the step S51 from the step S54. In addition, if the “selection according to the product category” button, the “selection according to the company (brand) name” button or the “selection according to the characters” button is selected, the process advances to a corresponding step from the step S54. For the sake of convenience, a description will be given of a case where the “selection according to product category” button is selected, as described above in conjunction with FIG. 10.

In this case, the process advances to a step S55 which displays the product category selection screen shown in FIG. 11. A step S56 decides whether the “OK” button or the “cancel” button is selected on the product category selection screen shown in FIG. 11 and whether a user operation is made on the product category selection screen. If the “OK” button is selected, the process advances to a step 57 from the step S56. The step S57 updates the data within the ad-setting user data part 26, and the process returns to the step S53. If the “cancel” button is selected, the process returns to the step S53 from the step S56. In addition, if the user operation is made on the product category selection menu, the process advances to a step S58 from the step S56. The step S58 recalculates the points of each page of the point list shown in FIG. 9 and updates the display, and the process returns to the step S55.

FIG. 14 is a flow chart for explaining creation and storage of the advertisement list. In FIG. 14, a step S61 decides whether or not the mode for independently selecting the advertisements is selected as the advertisement selection method on the details setting screen shown in FIG. 6. If the decision result in the step S61 is YES, a step S62 rearranges at random the advertisements selected by the user. A step S63 stores a list of rearranged advertisements into the advertisement insertion information part 29 shown in FIG. 1, as the advertisement list. A step S64 calculates the present number of points of the user, and the process ends. On the other hand, if the mode for semi-automatically selecting the advertisements is selected as the advertisement selection method and the decision result in the step S61 is NO, a step S65 selects the advertisements at random by the provider, from the selected product category, so as to match the ratios of the setting information. In addition, a step S66 stores a list of advertisements selected by the provider into the advertisement insertion information part 29, as the advertisement list, and the process advances to the step S64 described above.

When initially selecting the advertisements completely at random, the provider mode in which the receiving format is selected by the provider may be selected on the advertisement select mode selection screen or, the ratio for the provider's choice may be set to 100% on the product category selection screen shown in FIG. 11. In this case, the advertisements which are selected by the provider are distributed to the user according to the format selected by the provider. The user creates information indicating the user's taste (preference), and this information indicating the user's taste is stored at the provider end and/or the user end. The creation and storage of the information indicating the user's taste may be made on the details setting screen shown in FIG. 10 or on another setting screen.

Even when the advertisements are selected completely at random, it is desirable not to distribute to the user the advertisements which do not suit the user's taste and not to distribute the advertisements in the format which does not suit the user's taste. Hence, the advertisements and the receiving format which do not suit the user's taste may be stored in a log every time the user indicates the dislike for the advertisement and/or the receiving format by selecting a “reject” button, and the distribution of the advertisements may be made based on the log, so that the advertisements disliked by the user will not be distributed to the user and the receiving format disliked by the user will not be used with respect to the user.

The provider selects the advertisements and the format of the advertisements based on the information indicating the user's taste, and distributes to the user the selected advertisements which are in order or shuffled, with the selected format. The provider distributes the program (contents) selected by the user when the number of points owned by the user reaches the number required to receive the selected program or, when it becomes likely that the number of points owned by the user will reach the number required to receive the selected program. The provider can charge the advertising fees to the advertiser depending on the number of times the advertisement is distributed, for example.

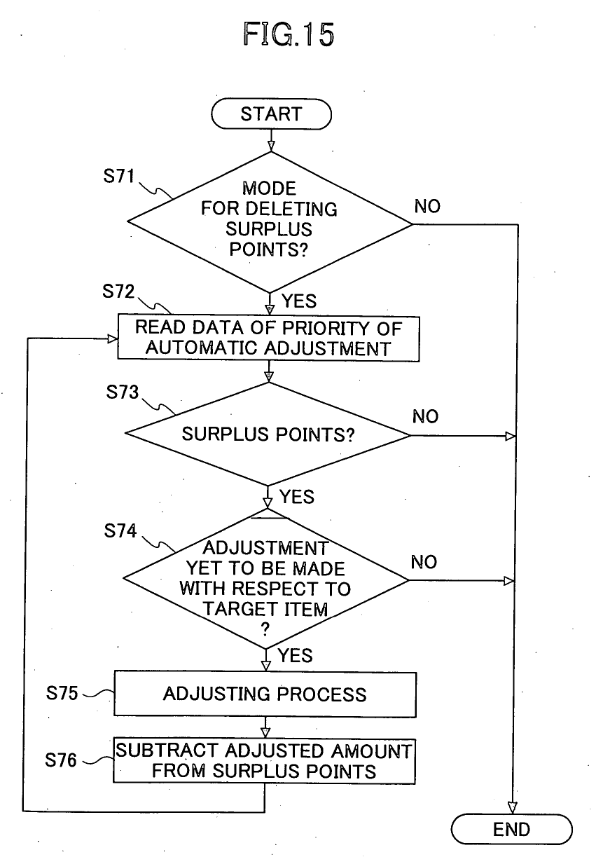

Next, a more detailed description will be given of the process of the step S6 shown in FIG. 2, by referring to FIGS. 15 through 19. FIG. 15 is a flow chart for explaining a portion of the process shown in FIG. 2 in more detail. More particularly, FIG. 15 shows the process of the step S6 in more detail.

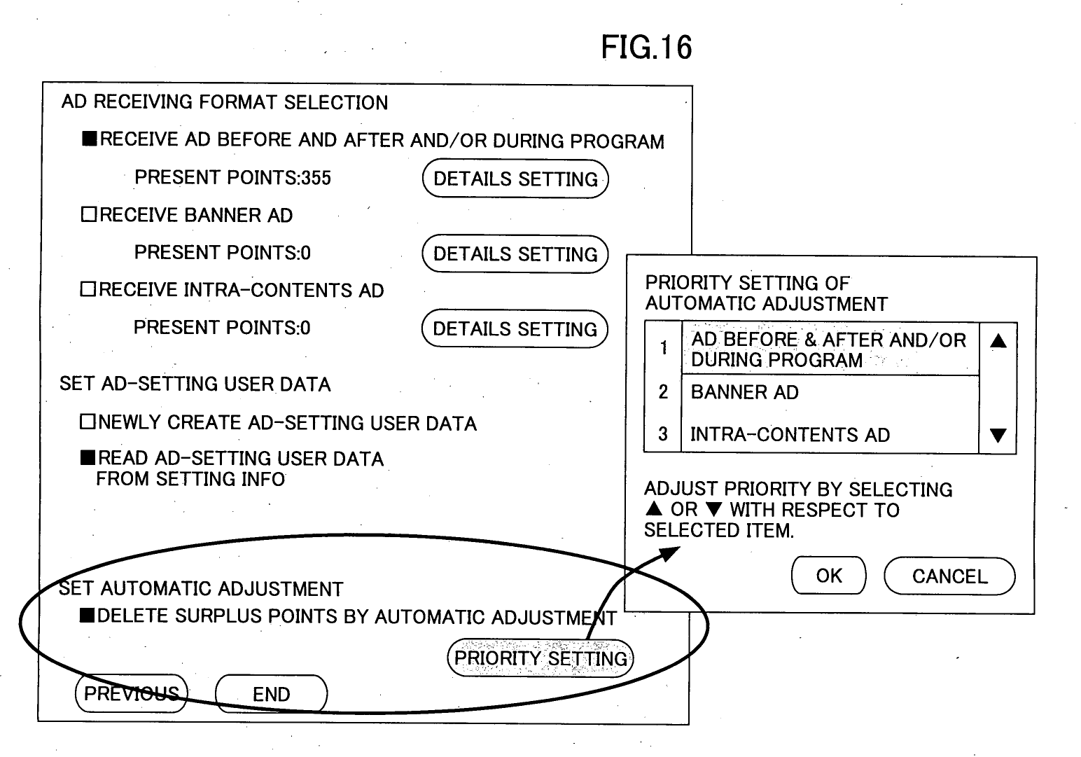

In a case where the computer system 2 has a function of setting automatic adjustment of the points, an advertisement receiving format selection screen shown in FIG. 16 is displayed on the display unit of the terminal equipment 3 in place of the advertisement receiving format selection screen shown in FIG. 5. FIG. 16 is a diagram showing the advertisement receiving format selection screen. In FIG. 16, those parts which are the same as those corresponding parts in FIG. 5 are shown with the same designations, and a description thereof will be omitted.

In the advertisement receiving format selection screen shown in FIG. 16, it is possible to select a mode which deletes surplus points by automatic adjustment, as a setting for the automatic adjustment of the points. When the mode which deletes the surplus points by the automatic adjustment is selected and a “priority setting” button is selected, a priority setting screen for automatic adjustment, which is shown on the right side of FIG. 16, is displayed on the display unit of the terminal equipment 3. The priority setting screen for the automatic adjustment may be displayed in an overlapping manner on the advertisement receiving format selection screen as shown in FIG. 16 or, displayed as a separate screen.

Items such as the advertisements before and after the program and/or during the program, the banner advertisements and the intra-contents advertisements are selectable on the priority setting screen for the automatic adjustment. The priority of the selected item can be changed by operating a “Δ” button and a “∇” button. When an “OK” button is selected, the selections made on the priority setting screen for the automatic adjustment are affirmed. On the other hand, when a “cancel” button is selected, the selections made of the priority setting screen for the automatic adjustment are cancelled.

In FIG. 15, a step S71 decides whether or not the mode for deleting surplus points by automatic adjustment is selected on the advertisement receiving format selection screen shown in FIG. 16, as a setting for the automatic adjustment of points. The process ends if the decision result in the step S71 is NO. On the other hand, if the decision result in the step S71 is YES, a step S72 reads data of the priority of the automatic adjustment which is set on the priority setting screen for the automatic adjustment. A step S73 decides whether or not surplus points exist, and the process ends if there are no surplus points and the decision result in the step S73 is NO. If there are surplus points and the decision result in the step S73 is YES, a step S74 decides whether or not an adjustment has yet to be made with respect to a target item which is to be adjusted. The process ends if the decision result in the step S74 is NO. If the decision result in the step S74 is YES, a step S75 carries out an adjusting process with respect to the target items which have not yet been adjusted, starting from the items having the high priority. A step S76 subtracts an adjusted amount from the surplus points, and the process returns to the step S72.

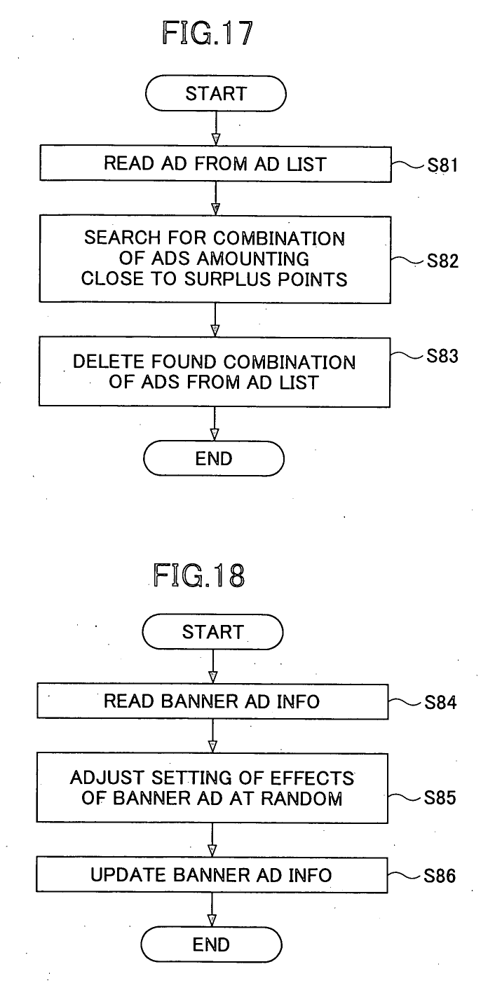

FIG. 17 is a flow chart for explaining an adjusting process of the step S75 shown in FIG. 15 for a case where the item having the high priority is the advertisement before and after the program and/or during the program. In FIG. 17, a step S81 reads the selected advertisement from the advertisement list within the advertisement insertion information part 29. A step S82 searches for a combination of advertisements which amount to a number of points close to a value which is less than or equal to the surplus points, from the combination of the selected advertisements. A step S83 deletes from the advertisement list the combination of advertisements found by the search in the step S83, and the process ends.

FIG. 18 is a flow chart for explaining an adjusting process of the step S75 shown in FIG. 15 for a case where the item having the high priority is the banner advertisement. In FIG. 18, a step S84 reads the banner advertisement information within the banner advertisement information part 22. A step S85 adjusts the setting of the effects of the selected banner advertisement at random in a direction so as to reduce the effects. A step S86 updates the banner advertisement information within the banner advertisement information part 22, based on the banner advertisement having the effects adjusted in the step S85, and the process ends.

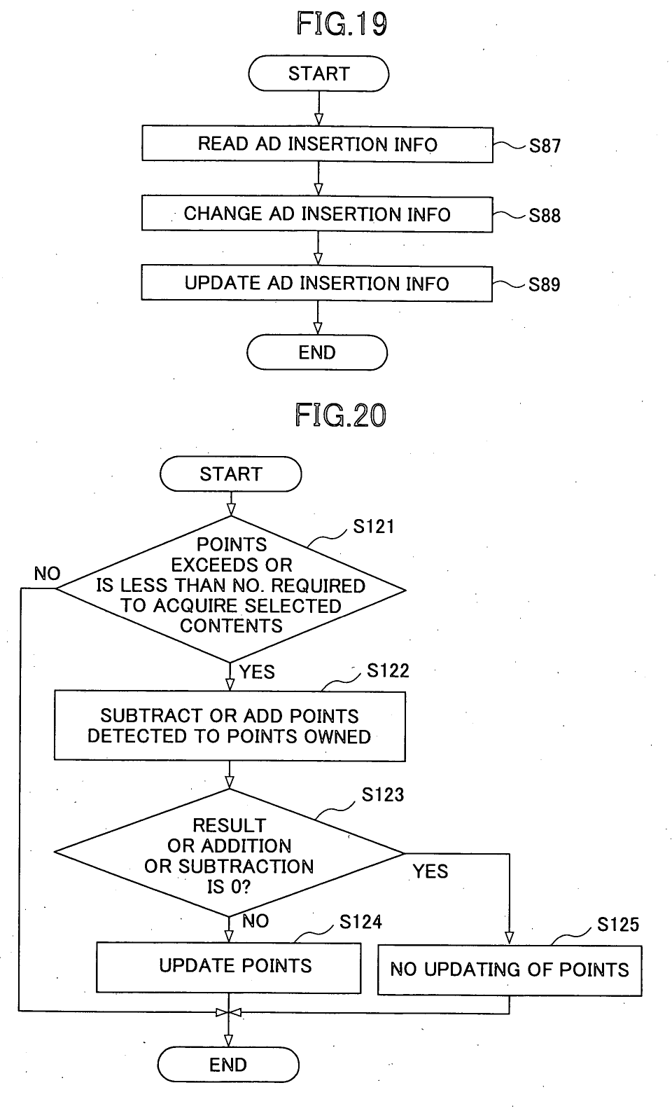

FIG. 19 is a flow chart for explaining an adjusting process of the step S75 shown in FIG. 15 for a case where the item having the high priority is the intra-contents advertisement. In FIG. 19, a step S87 reads the advertisement insertion information within the advertisement insertion information part 29. A step S88 changes the advertisement insertion information in a direction so as to eliminate the advertisement. A step S89 updates the advertisement insertion information within the advertisement insertion information part 29, based on the advertisement insertion information changed in the step S88, and the process ends.

In a case where the total number of points gained as a result of selecting the advertisements and/or the receiving format exceeds the number of points required to acquire the selected contents, it is troublesome to make fine adjustment of the points. On the other hand, the user may feel at a loss if the user receives advertisements which are more than necessary to acquire the selected contents. Accordingly, the advertisements and/or the receiving format amounting to the surplus (or unnecessary) points are automatically deleted. The priority information which determines which advertisement and/or which receiving format are to be deleted, is adjustable on the user end according to the setting made by the user. Therefore, it is possible prevent an undesirable situation where the user manually deletes an excessively large number of points, and the surplus points can be made inconspicuous in terms of the advertisements and/or the receiving format.

For example, suppose that a total of 355 points are gained by the user and there are 55 surplus points, as shown in FIG. 9. In this case, a fine adjustment amounting to the surplus points can be made by removing one or more advertisements from the receiving item. In addition, a fine adjustment amounting to the surplus points can also be made by slightly changing the setting with respect to the banner advertisements, such as that shown in the Table 1, that is, changing the setting of the banner advertisements in a direction so as to make the contents more easily visible (interfered less by the banner advertisements).

Next, a more detailed description will be given of a point pool and/or withdrawal process of the steps S7 and S8 shown in FIG. 2, by referring to FIG. 20. FIG. 20 is a flow chart for explaining a portion of the process shown in FIG. 2 in more detail. More particularly, FIG. 20 shows the process of the steps S7 and S8.

In FIG. 20, a step S121 decides whether or not the number of points exceeds or, is less than, the number of points required to acquire the contents selected by the user. The process ends if the decision result in the step S121 is NO. If the decision result in the step S121 is YES, a step S122 subtracts or adds the points owned by the user and read from the point accumulating part 27, from or to the number of points detected in the step S121. A step S123 decides whether or not a result of the subtraction or addition in the step S122 is less than or equal to zero. The process advances to a step S124 if the decision result in the step S123 is NO, and the process advances to a step S125 if the decision result in the step S123 is YES.

The step S124 judges that the number of points owned by the user has reached the number of points required to acquire the contents selected by the user, and updates the points of the user accumulated in the point accumulating part 27. In this case, the decision result in the step S8 shown in FIG. 2 becomes YES, and the process shown in FIG. 20 ends. Hence, the process advances to the step S9 shown in FIG. 2.

On the other hand, the step S125 judges that the number of points owned by the user has not reached the number of points required to acquire the contents selected by the user, and displays a message to the user on the display unit of the terminal equipment 3 to indicate that the number of points is insufficient to acquire the contents selected by the user, without updating the points of the user accumulated in the point accumulating part 27. In this case, the decision result in the step S8 shown in FIG. 2 becomes NO, and the process shown in FIG. 20 ends. Thus, the process returns to the step S4 shown in FIG. 2.

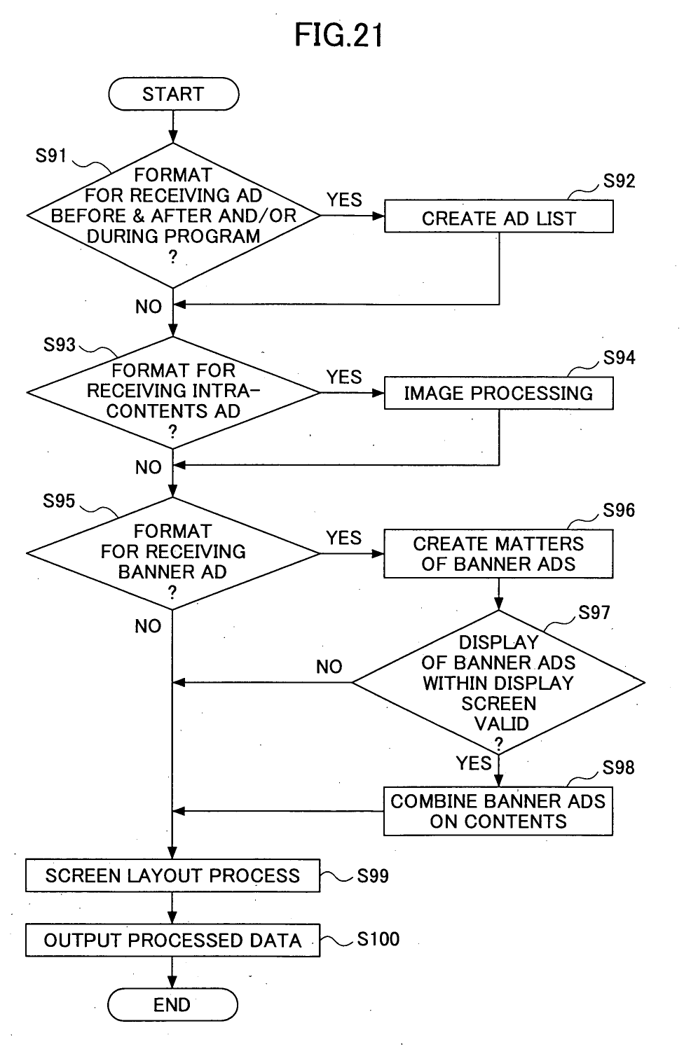

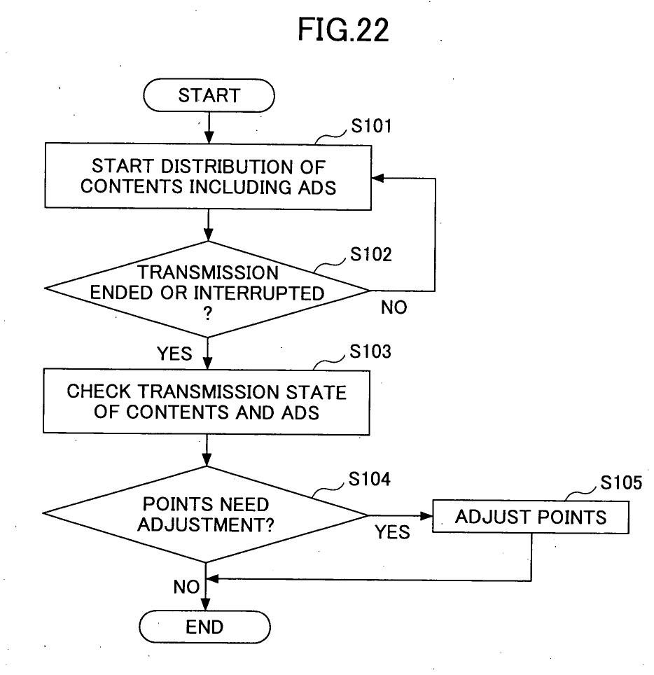

Next, a more detailed description will be given of the process of the steps S9 and S10 shown in FIG. 2, by referring to FIGS. 21 and 22.

FIG. 21 is a flow chart for explaining a portion of the process shown in FIG. 2 in more detail. More particularly, FIG. 21 shows the process of the step S9 in more detail. In FIG. 21, a step S91 decides whether or not the format for receiving the advertisements before and after the program and/or during the program is selected on the advertisement receiving format selection screen shown in FIG. 5, for example. If the decision result in the step S91 is YES, a step S92 creates an advertisement list in the advertisement insertion information part 29 and inserts the advertisements in the contents from the broadcasting contents part 21, by the image data combining part 23, according to the advertisement list. After the step S92 or, if the decision result in the step S91 is NO, a step S93 decides whether or not the format for receiving the intra-contents advertisements is selected on the advertisement receiving format selection screen shown in FIG. 5, for example. If the decision result in the step S93 is YES, a step S94 carries out an image processing with respect to the contents from the broadcasting contents part 21, by the image data combining part 23, using the advertisement insertion information within the advertisement insertion information part 29. The advertisements are combined into the contents by this imaging process.

After the step S94 or, if the decision result in the step S93 is NO, a step S95 decides whether or not the format for receiving the banner advertisements is selected on the advertisement receiving format receiving screen shown in FIG. 5, for example. If the decision result in the step S95 is YES, a step S96 creates the matters of the banner advertisements, by the image data combining part 23, according to the banner advertisement information within the banner advertisement information part 22. A step S97 decides whether or not the display of the banner advertisements in the Table 1, for example, within the display screen, is valid. The process advances to a step S98 if the decision result in the step S97 is YES. The step S98 combines the banner advertisements on the contents, by the image combining part 23, according to the α-blending or the like.

If the decision result in the step S95 or S97 is NO or, after the step S98, a step S99 carries out a screen layout process. Preprocessing of the Web server 28, such as the display of the banner advertisements, is included in the screen layout process. A step S100 outputs the processed data, including the contents and the advertisements, to the streaming server 25, and the process ends.

FIG. 22 is a flow chart for explaining a portion of the process shown in FIG. 2 in more detail. More particularly, FIG. 22 shows the process of the step S10 shown in FIG. 2 in more detail. In FIG. 22, a step S101 starts distribution of the contents, including the advertisements, from the streaming server 25. A step S102 decides whether or not the transmission of the contents has ended or whether or not the transmission of the contents has been interrupted. The process returns to the step S101 if the decision result in the step S102 is NO. If the decision result in the step S102 is YES, a step S103 checks the transmission state of the contents and the transmission state of the advertisements. More particularly, the step S103 carries out a user reception state and/or end confirmation process in the computer system 2 or the terminal equipment 3, to check whether or not the advertisements and the contents have been distributed up to the end. A step S104 decides whether or not the number of points gained by the user needs to be adjusted. If the decision result in the step S104 is YES, a step S105 adjusts the number of points of the user accumulated in the point accumulating part 27 by adding or subtracting points. If the decision result in the step S104 is NO or, after the step S105, the process ends.

The user may dislike interruptions during the program. In such a case, the user may set the advertisement collective reception method on the details setting screen shown in FIG. 6, so as to collectively receive the advertisements. As a result, the program is distributed to the user continuously without being interrupted. Since the provider can obtain the information related to the settings made by the user on the details setting screen shown in FIG. 6 from the Web server 28, the provider can distribute all of the advertisements to the user before the distribution of the program, including the advertisements which should originally be inserted during the program. However, when the advertisements are distributed in succession to the user, the user may leave his seat and do something else while the advertisements are being collectively received. Hence, considering the possibility that the advertising effect of the advertisements which are collectively distributed may not be as high as the advertisements which are distributed in divisions, that is, before and after the program and/or during the program, the number of points gained by collectively receiving the advertisements may be set lower than the case where the advertisements are received in divisions.

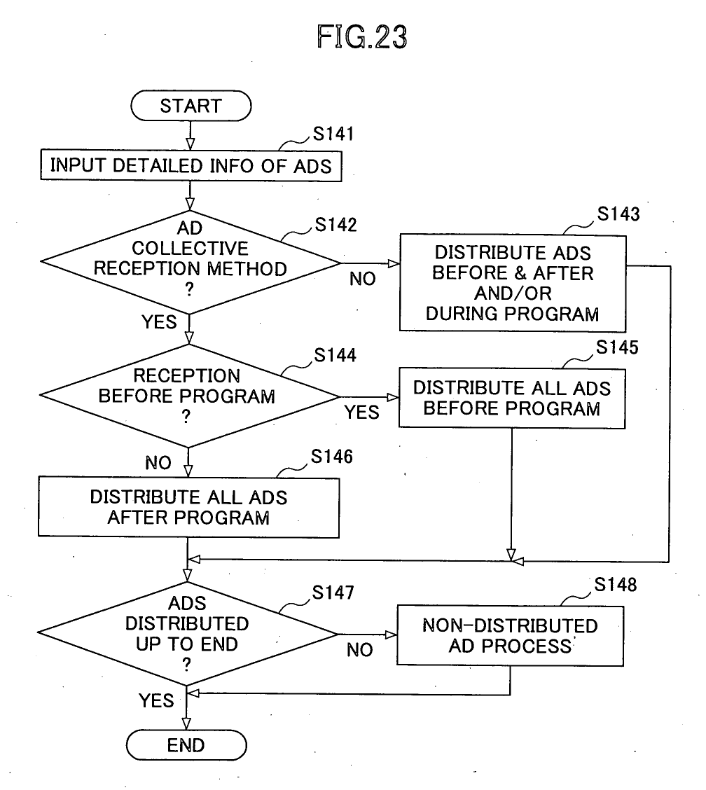

Next, a more detailed description will be given of the other processes carried out by the step S10 shown in FIG. 2, by referring to FIG. 23. FIG. 23 is a flow chart for explaining a process of the step 10 which is dependent on the settings made on the details setting screen shown in FIG. 6. In FIG. 23, a step S141 inputs detailed information of the advertisements which are set by the user on the details setting screen shown in FIG. 6, and a step S142 decides whether or not the advertisement collective reception method for collectively receiving the advertisements is set. If the decision result in the step S142 is NO, a step S143 inserts and distributes the advertisements before and after the program and/or during the program, and the process advances to a step S147 which will be described later. On the other hand, if the decision result in the step S142 is YES, a step S144 decides whether or not the reception before the program is set for the advertisement collectively reception method.

If the decision result in the step S144 is YES, a step S145 distributes all of the advertisements before the program, and the process advances to the step S147 which will be described later. If the decision result in the step S144 is NO, a step S146 distributes all of the advertisements after the program, and the process advances to the step S147. The step S147 decides whether or not the advertisements have been distributed up to the end (that is, up to the last advertisement). If the decision result in the step S147 is NO, a step S148 carries out a non-distributed advertisement process. The non-distributed advertisement process subtracts the number of points corresponding to the non-distributed advertisements from the number of points owned by the user. If the number of points becomes a negative value as a result of this subtraction by the non-distributed advertisement process, it is possible to take measures so that the user cannot receive the selected contents unless the user receives the advertisements which will make the number of points owned by the user a positive value or, so that the user will first receive the remaining advertisements which were previously not received before the user is able to receive the next selected contents. Of course, in a case where not all of the contents are distributed to the user, it is possible to similarly add a number of points corresponding to the non-distributed contents to the number of points owned by the user. After the step S148 or, if the decision result in the step S147 is YES, the process ends.

In addition to the points which are gained depending on the advertisements received and the receiving format selected by the user, it is possible to give away gift points to the user when the user makes a correct answer to a quiz, so that the gift points may be added to the pooled points. Moreover, it is possible to give away gift points to the user who answers questionnaires. The questionnaire may include questions asking impressions and the like of the advertisements received by the user, and the gift points may be given to the user for each answered question, for example. Furthermore, the quizzes may be distributed to the user together with the advertisements, in the form of quiz-type advertisements.

In the above case, the user not only gains points by receiving the advertisements, but also gains gift points by enjoying and answering the quizzes or questionnaires, and the gained points may be effectively utilized to receive the desired contents. On the other hand, the advertiser can appeal to the user by giving the quizzes or questionnaires related to the matters of interest to the advertiser, so that the information obtained through the answers to the quizzes or questionnaires may be used to make the advertising products more appealing to the users. The advertiser can also make an opportunity for the user to know more about the advertising products. The questionnaires can also provide the advertiser with a means of easily and freely gathering opinions or comments from the users.

When making the quizzes using the quiz-type advertisement, the rules may be described within the advertisement. For example, the rules may state that 5 gift points are given away for every correct answer out of 10 quizzes, and that 30 bonus points will be given in addition to the 50 gift points if the answers to all of the 10 quizzes are correct. When the user answers the quizzes, the results are gathered in the Web server 28 or the like, and the gift points dependent on the results, that is, the correct answers, are given away to the user.

For example, the questionnaires including 10 questions may be sent using the quiz-type advertisement. When the user answers the questions, the results are gathered in the Web server 28 or the like, and the gift points dependent on the results, that is, the number of questions answered, are given away to the user.

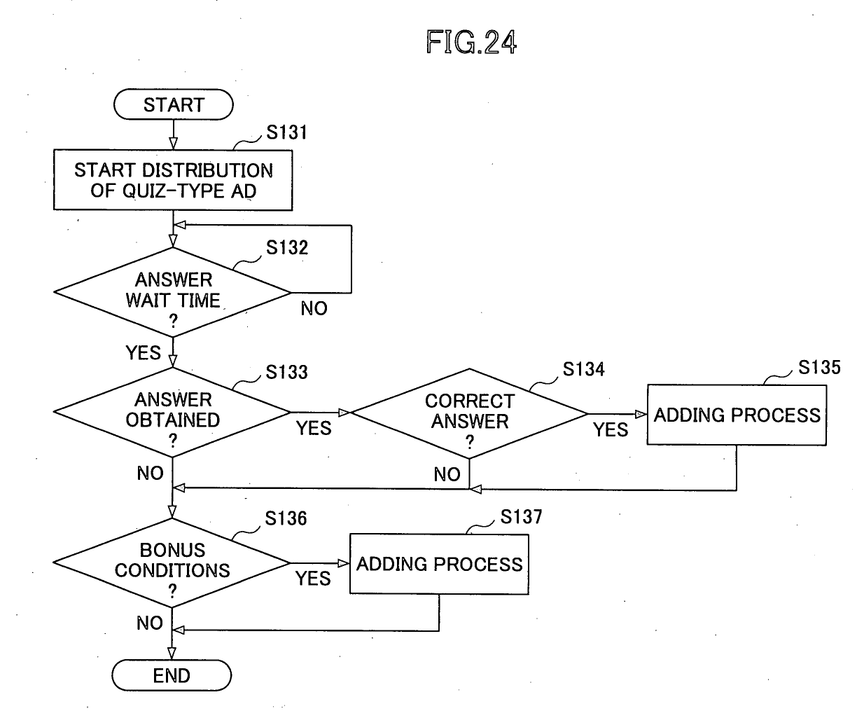

FIG. 24 is a flow chart for explaining a point give-away process which distributes the quiz-type advertisements and gives away gift points to the user. In FIG. 24, a step S131 starts distribution of the quiz-type advertisements. For example, the quiz-type advertisements may be distributed based on the setting made by the user or the provider. A step S132 decides whether or not an answer wait time has elapsed from a time when a quiz is given to the user. If the decision result in the step S132 becomes YES, a step S133 decides whether or not an answer to the quiz is obtained from the user. If the decision result in the step S133 is YES, a step S134 decides whether or not the answer is correct. If the decision result in the step S134 is YES, a step S135 carries out an adding process to add gift points corresponding to the correct answer to the points of the user accumulated in the point accumulating part 27.

If the decision result in the step S133 or S134 is NO or, after the step S135, a step S136 decides whether or not bonus conditions, such as correct answers to all of the quizzes, are satisfied. If the decision result in the step S136 is YES, a step S137 carries out an adding process to add bonus points, which are given away when the bonus conditions are satisfied, to the points of the user accumulated in the point accumulating part 27. If the decision result in the step S136 is NO or, after the step S137, the process ends.

Therefore, the points of the user can be increased and decreased, that is, adjusted, depending on specific conditions other than the advertisements and the formats of the advertisements. The specific conditions are, for example, the non-distributed advertisements and/or contents, gifts and bonuses. Consequently, it is possible to carry out fine and detailed management of the points for each user.

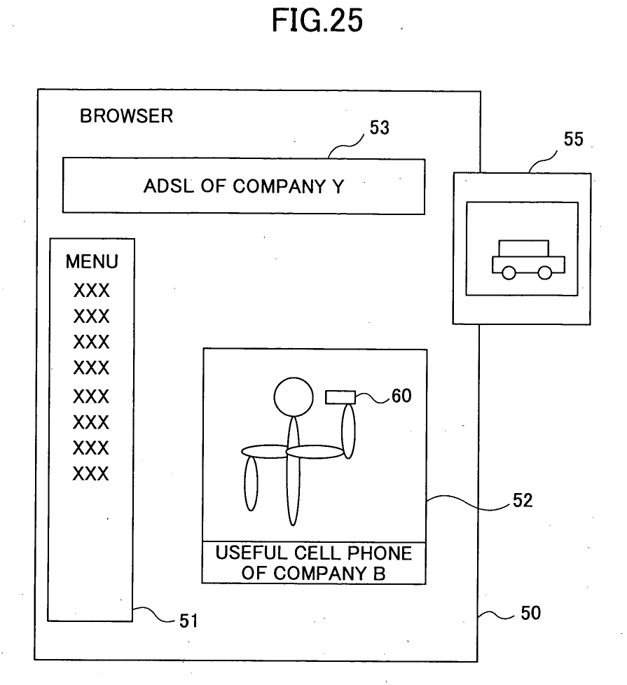

FIG. 25 is a diagram showing the formats of the advertisements received by the terminal equipment 3 and displayed on the display unit of the terminal equipment 3. A menu 51, a display screen 52, a banner advertisement 53 outside the display screen 52, a banner advertisement 54 inside the display screen 52, and a sub-window 55 are displayed in a browser screen 50 shown in FIG. 25. As an example of the intra-contents advertisement, a product 60 which is to be advertised, is included within the contents that are displayed in the display screen 52.

When distributing the advertisement before and after the contents and/or during the contents, the advertisement and the contents are alternately displayed within the display screen 52. In this state, at least one of the banner advertisements 53 and 54 may be displayed. In addition, it is also possible to display an advertisement within the sub-window 55. In this case, it is desirable not to reproduce the audio corresponding to the matters displayed in the sub-window 55, and to reproduce only the audio corresponding to the matters displayed within the display screen 52.

An advertisement similar to the advertisement distributed before and after the program may be displayed in the sub-window 55. However, when the sub-window 55 is displayed with a large size, it becomes difficult to distinguish the sub-window 55 and the display screen 52. Hence, in this case, it is possible to give points depending on whether the audio being reproduced corresponds to the display screen 52 or the sub-window 55. In other words, the points corresponding to the advertisement before and after the program may be given if the audio of the advertisement is reproduced, and the points corresponding to the advertisement before and after the program may be reduced by a certain percentage if the audio of the program is reproduced. For example, a number of points obtained from [(points of advertisement)×(fixed 30%)×(size ratio of the contents and the display screen)] may be given to the user when the audio of the program is reproduced.

Further, the present invention is not limited to these embodiments, but various variations and modifications may be made without departing from the scope of the present invention.

1. An information distribution method for distributing contents and advertisements from a provider to a user apparatus via a network, comprising:
distributing an advertisement with a format requested from the user apparatus.

2. The information distribution method as claimed in claim 1, wherein the format is determined depending on at least one parameter selected from a group of parameters consisting of parameters related to time restrictions, parameters related to image restrictions, parameters related to attribute restrictions, and parameters related to audio restrictions.

3. The information distribution method as claimed in claim 1, further comprising:
managing points depending on the advertisement and the format; and
controlling distribution of the contents depending on the points.

4. The information distribution method as claimed in claim 3, wherein said managing points independently manages the points with respect to each of the contents or, manages the points in common with respect to a plurality of contents.

5. The information distribution method as claimed in claim 3, further comprising:
adjusting the points depending on specific conditions other than the advertisement and the format.

6. The information distribution method as claimed in claim 3, further comprising:
allocating surplus points to other contents if a number of points required to receive one content by the user apparatus is exceeded.

7. A computer-readable storage medium which stores a program for causing a computer to distribute contents and advertisements to a user apparatus via a network, said program comprising:
a procedure causing the computer to distribute an advertisement with a format requested from the user apparatus.

8. The computer-readable storage medium as claimed in claim 7, wherein the format is determined depending on at least one parameter selected from a group of parameters consisting of parameters related to time restrictions, parameters related to image restrictions, parameters related to attribute restrictions, and parameters related to audio restrictions.

9. The computer-readable storage medium as claimed in claim 7, wherein said program further comprises:
a procedure causing the computer to manage points depending on the advertisement and the format; and
a procedure causing the computer to control distribution of the contents depending on the points.

10. The computer-readable storage medium as claimed in claim 7, wherein said program further comprises:
a procedure causing the computer to urge the user apparatus to specify the requested format.

11. An information distribution apparatus for distributing contents and advertisements from a provider to a user apparatus via a network, comprising:
a unit to distribute an advertisement with a format requested from the user apparatus.

12. The information distribution apparatus as claimed in claim 11, wherein the format is determined depending on at least one parameter selected from a group of parameters consisting of parameters related to time restrictions, parameters related to image restrictions, parameters related to attribute restrictions, and parameters related to audio restrictions.

13. The information distribution apparatus as claimed in claim 11, further comprising:
a unit to manage points depending on the advertisement and the format; and
a unit to control distribution of the contents depending on the points.

14. A business method for providing free contents service to a user by distributing contents and advertisements from a provider computer to a user apparatus via a network, and charging advertising fees for the advertisements to an advertiser, said business method comprising:
managing points depending on an advertisement and a format requested from the user apparatus; and
distributing the advertisement with the format requested from the user apparatus, and controlling distribution of the contents depending on the points.

15. The business method as claimed in claim 14, wherein the format is determined depending on at least one parameter selected from a group of parameters consisting of parameters related to time restrictions, parameters related to image restrictions, parameters related to attribute restrictions, and parameters related to audio restrictions.

16. The business method as claimed in claim 14, further comprising:
urging the user apparatus to specify the requested format.

17. The business method as claimed in claim 14, further comprising:
charging the advertising fees for the advertisement to the advertiser depending on the points accumulated for the advertisement.
